(19) United States
(12) Patent Application Publication
(10) Pub. No.: US 2025/0218233 A1
(43) Pub. Date: Jul. 3, 2025

(54) MULTI-FACTOR AUTHENTICATION FOR PREMISES MONITORING SYSTEMS

(71) Applicant: The ADT Security Corporation, Boca Raton, FL (US)

(72) Inventor: Tai NGUYEN, Glenside, PA (US)

(21) Appl. No.: 18/990,560

(22) Filed: Dec. 20, 2024

Related U.S. Application Data
(60) Provisional application No. 63/616,178, filed on Dec. 29, 2023.

(51) Int. Cl. G07C 9/00

(52) U.S. Cl. CPC G07C 9/00174

(57) ABSTRACT

A system is provided. The system includes a computing environment. The computing environment is configured to receive a recognized person message indicating a recognized person has been detected proximate an access location of the premises, receive a connection message, where the connection message indicating a wireless connection has been established between a premises monitoring system and a mobile device corresponding to the recognized person, and in response to at least receiving the recognized person message and the connection message: cause the premises monitoring system to disarm and cause an electronic door lock securing the access location of the premises to unlock.

### CROSS-REFERENCE TO RELATED APPLICATIONS

This application claims priority to U.S. Provisional Application No. 63/616,178, filed Dec. 29, 2023, entitled “MULTI-FACTOR AUTHENTICATION FOR PREMISES MONITORING SYSTEMS,” the entirety of which is incorporated herein by reference.

### TECHNICAL FIELD

The present technology is generally related to multi-factor authentication in a premises monitoring system.

### BACKGROUND

Home burglar alarm systems and other types of premises monitoring systems can be used to monitor a premises for detectable events that may trigger an alarm or some other action when the premises monitoring system is in an armed state. Some premises monitoring systems can also control access to a premises by, for example, locking and unlocking entrances to the premises.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a block diagram of an example system according to some embodiments of the present disclosure;

FIG. 2 is a block diagram of another example system according to some embodiments of the present disclosure;

FIG. 3 is a block diagram of an example control device of the system of FIG. 1 and/or FIG. 2 according to various embodiments of the present disclosure;

FIG. 4 is a block diagram of example premises devices of the system of FIG. 1 and/or FIG. 2 according to various embodiments of the present disclosure;

FIG. 5 is a block diagram of an example mobile device of the system of FIG. 1 and/or FIG. 2 according to various embodiments of the present disclosure;

FIG. 6 is a block diagram of an example remote monitoring system of FIG. 1 and/or FIG. 2 according to various embodiments of the present disclosure;

FIG. 7 is a flowchart of example functionality performed by a premises device of FIGS. 1 and/or 2 according to various embodiments of the present disclosure;

FIG. 8 is a flowchart of example functionality performed by another premises device of FIGS. 1 and/or 2 according to various embodiments of the present disclosure;

FIG. 9 is a flowchart of example functionality performed by a mobile device of FIGS. 1 and/or 2 according to various embodiments of the present disclosure;

FIG. 10 is a flowchart of example functionality performed by an access control platform of FIGS. 1 and/or 2 according to various embodiments of the present disclosure; and

FIG. 11 is a sequence diagram of example functionality performed by various components of FIGS. 1 and/or 2 according to various embodiments of the present disclosure.

### DETAILED DESCRIPTION

The present disclosure relates to multi-factor authentication in a premises monitoring system.

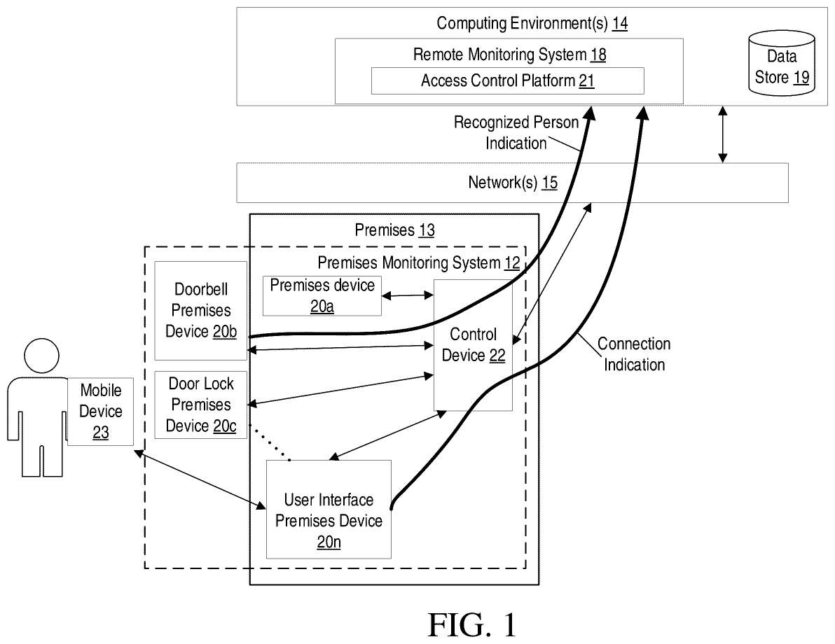

Referring to the drawing figures, in which like elements are referred to by like reference numerals, there is shown in FIG. 1 a diagram of an example system 10 according to some embodiments of the present disclosure. System 10 may include premises monitoring system 12 and one or more computing environments 14 that may be in communication with each other via one or more networks 15 (collectively referred to as network 15). In embodiments described herein, the joining term, “in communication with” and the like, may be used to indicate electrical or data communication, which may be accomplished by physical contact, induction, electromagnetic radiation, radio signaling, infrared signaling or optical signaling, for example. Multiple components may interoperate and modifications and variations are possible to achieve the electrical and data communication. In some embodiments described herein, the term “coupled,” “connected,” and the like, may be used herein to indicate a connection, although not necessarily directly, and may include wired and/or wireless connections.

Premises monitoring system 12 may be configured to provide functionality relating to premises monitoring. For example, premises monitoring system 12 may be used to detect burglaries, smoke, fires, carbon monoxide leaks, water leaks, etc. and report detected events to remote monitoring system 18 of computing environment 14. Additionally, the premises monitoring functionality performed by premises monitoring system 12 may include home automation functionality. Examples of home automation functionality include thermostat control, door lock control, lighting control, appliance control, entertainment system control, etc.

Premises monitoring system 12 may include one or more premises devices 20a-20n (collectively referred to as “premises device 20”) for providing one or more of monitoring functionality, home automation functionality, etc. Premises device 20 may be in communication with control device 22 via one or more networks such as, for example, a local area network at premises 13 and/or short range wireless protocol network (e.g., BLUETOOTH, BLUETOOTH LOW ENERGY (BLE), ultra-wideband (UWB), ZIGBEE, Z-WAVE, among other Institute of Electrical and Electronics Engineers (IEEE) based short range wireless protocols, etc.). For example, in one or more embodiments, user interface premises device 20n may communicate wirelessly with computing environment 14 via Wi-Fi, or may communicate wirelessly with control device 22 via Z-WAVE, ZIGBEE, etc. for example, in one or more embodiments, door lock premises device 20c may communicate wirelessly with control device 22 or user interface premises device 20n via Z-Wave, ZigBee, etc.

Premise device 20 may include one or more sensors, devices configured to capture audio, images, and/or video, and/or other devices. For example, premises devices 20 may include motion sensors, fire sensors, smoke sensors, heat sensors, carbon monoxide sensors, flood sensors, flow sensors, temperature sensors, humidity sensors, proximity sensors, contact sensors, glass break sensors, water consumption sensors, water pressure sensors, etc. Devices configured to capture audio, images, and/or video may include still image cameras, video cameras, microphones, etc. Additional examples of premises devices 20 include sirens, garage door controllers, smart doorbells (e.g., video doorbell camera configured to capture audio, images and/or video), temperature sensors, humidity sensors, lighting devices, switches, electrical outlets, door locks, premises locks, and electrical plugs. For example, a video doorbell camera may be configured to identify or recognize a specific person in a video generated by the video doorbell camera.

Premises device 20 may include one or more user interface devices that are in communication with control device 22. The user interface device may include a user interface, such as one or more buttons, a touch screen, a display, a microphone, a speaker, and/or other types of user interface components. According to various embodiments, the user interface device may be, for example, a keypad device, such as a wall-mountable keypad device configured to be installed near an entrance of the premises 13, that a user may operate to arm and disarm the premises monitoring system 12. In one or more embodiments, one or more premises devices 20, including but not limited to user interface devices, may include a dedicated short-range wireless communication protocol radio. For example, a dedicated short-range wireless communication protocol device may be positioned proximate to an entry or access point to premises 13 where mobile device 23 communicates with the dedicated short-range wireless communication protocol device, and the dedicated short-range wireless communication protocol device communicates with user interface premises device 20n.

Mobile device 23 may be, for example, a smartphone, a smartwatch, a wearable computer, a tablet computer, etc. associated with a user. A mobile application (not shown) may be installed in mobile device 23. The mobile application may be associated with premises monitoring system 12 and configured to, for example, provide functionality for monitoring, controlling aspects of premises monitoring system 12, providing authentication data (e.g., security credential, security token, security key, etc.) establishing a wireless connection with user interface premises device 20n, transmitting a connection indication (e.g., authentication indication) to computing environment 14, etc. In some embodiments, the authentication data provided by mobile device 23 may be used by computing environment 14 to authenticate a person associated with mobile device 23 and determine that the person is present at premises 13.

System 10 further comprises control device 22 that may be configured to control various aspects of premises monitoring system 12 and/or communicate with remote monitoring system 18. According to various embodiments, the control device 22 may be, or include, a wall-mountable panel device (e.g., a wall-mounted alarm system panel), a tabletop panel device (e.g., a tabletop alarm system panel), an alarm control panel having an enclosure and hinged door configured to be mounted in a closet, etc. Further, the control device 22 may have a short-range wireless communication radio that facilitates communication with one or more premises devices 20 and/or other devices via one or more short-range wireless communication protocols. Control device 22 may be configured to control premises devices 20, such as locks (e.g., electronic door locks), doors, windows, actuators, valves, motors, and any other controllable devices associated with premises monitoring system 12. According to various embodiments, control device 22 may be a gateway device, an alarm system panel, a hub and/or another type of device configured to control aspects of premises monitoring system 12.

Further, computing environment 14 may include remote monitoring system 18, data store 19, and access control platform 21. Remote monitoring system 18 may be configured to provide remote monitoring services for multiple premises monitoring systems 12. For example, in the event that an open door, open window, glass break, etc. is detected by a premises device 20 when premises monitoring system 12 is in an armed state, premises monitoring system 12 may transmit an alarm signal to remote monitoring system 18. In response, remote monitoring system 18 and/or a human monitoring agent associated with remote monitoring system 18 may notify first responders, such as police, fire, emergency medical responders, etc., and/or one or more designated peoples associated with the premise monitoring system 12. According the various embodiments, the notification can be a telephone call, an electronic message, etc. to a public-safety answering point (PSAP) that handles communications for first responders.

Access control platform 21 may be further configured to allow temporary access (e.g., time-based access, alarm-based access, event-based access, guest access, etc.) to premises 13 to one or more people based at least on an access policy stored in data store 19. In particular, access control platform 21 may be configured to provide one or more types of access to premises 13 via premises monitoring system 12. For example, certain types of users may be provided access to premises 13 for different types of access control. Different types of users may include, for example, designated family members of at least one person associated with premises 13; designated neighbors near premises 13; designated vendors and assistants, such as dog walkers, housekeepers, pet sitters, contractors, etc., designated guests, etc.

Further, the different types of access control may include time-based access, alarm-based access, event-based access or guest access. Time-based access may provide a person (e.g., person recognized by user interface premises device 20n) with a specified time to access one or more portions of premises 13, such as when a homeowner, resident or other person associated with premises 13 is temporarily away from premises 13 and may want someone to enter premises 13 for a limited amount of time. Alarm-based access may correspond to access that is triggered by an alarm event, such as an alarm event detected by premises monitoring system 12, which may include, for example, leak detection alarms, smoke alarms, carbon monoxide alarms, intrusions alarms, etc. and/or other event that may indicate a danger to life or property. Hence, controlled access to the premises may be provided to one or more designated users in response to one or more alarms to facilitate access to the premises 13 and potentially prevent or reduce harm to property and life. Event-based access may correspond to providing one or more designated users access to premises 13 based on an event detected by computing environment 14 and/or components of premises monitoring system 12. For example, in response to premises monitoring system 12 and/or remote monitoring system 18 detecting a person having fallen in the premises 13 based on video analytics, access control platform 21 may grant access to premises 13, after authentication described herein, to help the individual who fell. Guest access may include providing one or more guests access to premises 13 for a specific purpose. For example, the guest may be a dog walker who requires temporary access to premises 13 to get and walk the dog.

In particular, access control platform 21 may be configured to perform functionality related to granting access, if any, to an authenticated person. For example, access control platform 21 may be configured to authenticate a person, and in response, retrieve access data or an access profile for the authenticated person. The access data or access profile may be stored in data store 19 and may indicate the one or more types of access control that are applicable to the user and one or more rules (e.g., criterion, criteria, access policies) that specify when to grant access. That is, one or more pre-configured rules may be stored in data store 19 and specify the type(s) of authentication acceptable for a particular user and how many authentication factors are required for the access control platform 21 to grant the person access to premises 13. The one or more rules may be based on one or more of: day(s) of the week, time(s) of day, type of triggered alarm, type of detected event, type of vendor, the purpose of the person accessing the premises 13, etc. Access control platform 21 may function as a rules engine and may ensure premises monitoring system 12 is disarmed prior to unlocking a door to prevent false alarms.

In one or more embodiments, one or more types of access can be combined with additional rules or conditions, such as rules or conditions based on one or more of time of day, day of the month, premises monitoring system 12 modes (e.g., armed away, vacation mode, etc.) or a number of occurrences. The number of occurrences can be used to allow entry to premises 13 only a prescribed number of times, such as one time where subsequent access attempts will fail.

Data store 19 may be configured to store various information and/or data associated with authenticating a person as described herein and with the type of access to be provided to an authenticated person. For example, data store 19 may store at least one authentication criterion (e.g., a rule) that specifies one or more conditions required for a person to be deemed authenticated for the purpose of granting the person access to premises 13. In some embodiments, the authentication criteria define one or more rules that must be satisfied for a person to be deemed authenticated for the purpose of granting access to premises 13. One example of a rule requires authentication to occur, within a time window, based on two or more forms of authentication data (e.g., recognized person indication, connection indication, etc.). The time window may be initiated, for example, upon the access control platform 21 receiving the recognized person indication. For example, in response to receiving the recognized person indication (e.g., first authentication data), remote monitoring system 18 or access control platform 21 may trigger a countdown timer, and connection indication may be required to be received before expiration of the timer in order to meet a rule.

In one or more embodiments, data store 19 and/or doorbell premises device 20b may store identification information for a plurality of people (e.g., family members, guests, vendors, providers, etc.) who may be provided a type of access described herein. Identification information may include facial recognition data (e.g., face library), biometric data, among other data associated with one or more characteristics of a person.

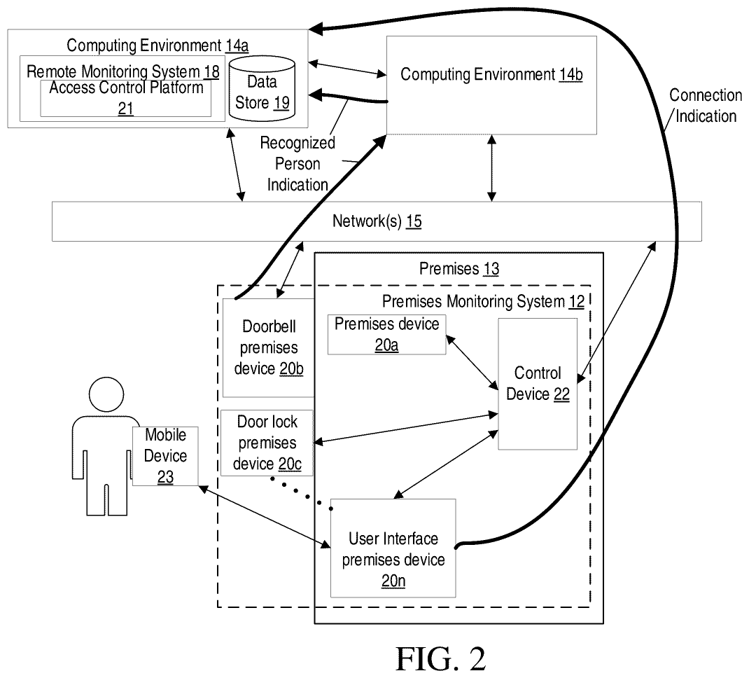

FIG. 2 is a diagram of another example of a system 10. In the example of FIG. 2, system 10 includes computing environment 14 (now referred to as computing environment 14a) as described with respect to FIG. 1. As shown in FIG. 2, the system 10 further includes computing environment 14b operated by a third-party relative to the operator of the remote monitoring system 18 and/or access control platform 21. Computing environment 14b may include one or more computing systems that provide computing resources for computing environment 14a, the user of mobile device 23, and/or others. For example, computing environment 14b may provide remote data storage, cloud computing resources, and/or other resources for computing environment 14a, the user of mobile device 23, and/or others. As discussed herein, the doorbell premises device 20b may be configured to transmit various data to computing environment 14b. Computing environment 14b may be configured to perform one or more functions using data captured by and/or received from doorbell premises device 20b, described herein.

Doorbell premises device 20b may be configured to capture media data such as audio, images, and/or video. To this end, doorbell premises device 20b may be, for example, a smart doorbell with one or more cameras and microphones, a smart lock with one or more image cameras and microphones, or a security camera with one or more image sensors 56 and microphones. According to some embodiments, doorbell premises device 20b may be configured to detect a person in captured media data using facial recognition analytic(s) applied to at least a portion of the media data. For example, doorbell premises device 20b may be configured to perform facial recognition on media data to determine whether the analyzed media data matches a known facial profile of a user, i.e., to detect a recognized face of a person in the video generated by doorbell premises device 20b. The known facial profile may correspond to a facial profile of a family member, vendor, guest or helper. In some embodiments, if the analyzed media data matches a known facial profile, the doorbell premises device 20b transmits an indication (e.g., recognized person indication, authentication data, etc.) to computing environment 14b via network 15 where the indication transmitted by doorbell premises device 20b indicates a recognized person was detected in media data by doorbell premises device 20b. The indication transmitted by doorbell premises device 20b may include image data, video data and/or an indication of a result of facial recognition performed on the image data and/or the video data.

Computing environment 14b may be configured to transmit the recognized person indication to computing environment 14a where the recognized person indication corresponds to an authentication indication usable by the computing environment 14b as part of the determination of whether to authenticate the recognized person with the premises monitoring system 12.

In some embodiments, computing environment 14b may be configured to perform analytics operations on the data received from premises device 20. For example, computing environment 14b may be configured to perform facial recognition on media data received from doorbell premises device 20b to determine whether the analyzed media data matches a known facial profile. In some embodiments, if the analyzed media data matches a known facial profile, computing environment 14b may transmit a message to computing environment 14a indicating that a known person was detected in the media data.

Computing environment 14a may determine whether an authentication criteria is met based on, for example, (1) the message from the computing environment 14b indicating that a known person has been detected in media data from the doorbell premises device 20b and (2) the authentication received from the mobile device 23 via the premises monitoring system 12, as described herein.

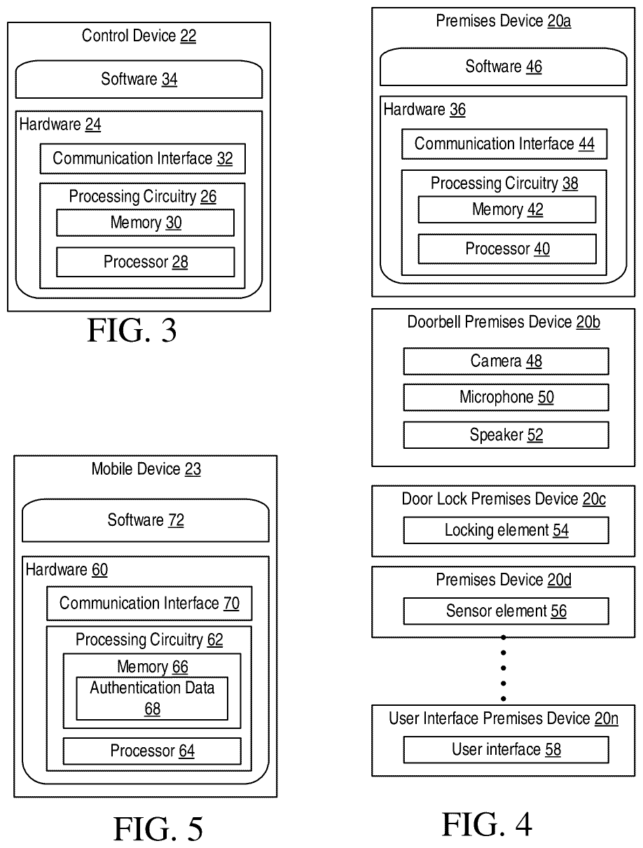

FIG. 3 shows a block diagram illustrating an example control device 22 of premises monitoring system 12. As shown, control device 22 comprises hardware 24. The hardware 24 may include processing circuitry 26. The processing circuitry 26 may include one or more processors 28 and one or more memories 30. Each processor 28 may include and/or be associated with one or more central processing units, data buses, buffers, and interfaces to facilitate operation. In addition to or instead of a processor 28 and memory 30, the processing circuitry 26 may comprise other types of integrated circuitry that perform various functionality. Integrated circuitry may include one or more processors 28, processor cores, field programmable gate arrays (FPGAs), application specific integrated circuits (ASICs), graphics processing units (GPUs), systems on chips (SoCs), or other components configured to execute instructions. The processor 28 may be configured to access (e.g., write to and/or read from) the memory 30, which may comprise any kind of volatile and/or nonvolatile memory, e.g., cache, buffer memory, random access memory (RAM), read-only memory (ROM), optical memory, and/or erasable programmable read-only memory (EPROM). Further, memory 30 may be embodied in the form of one or more storage devices. The processing circuitry 26 may be configured to perform various functionality described herein. For example, computer instructions may be stored in memory 30 and/or another computer-readable medium that, when executed by processor 28, causes the processor 28 to perform various functionality described herein.

Hardware 24 may include communication interface 32 facilitating communication between control device 22 and one or more elements in system 10. For example, communication interface 32 may be configured for establishing and maintaining at least a wireless or wired connection with one or more elements of system 10 such as premises device 20 and/or computing environment 14. In one or more embodiments, communication interface 32 may include a plurality of radios where a first radio is used to wirelessly communicate with one or more premises devices via Z-WAVE, ZIGBEE, etc., and a second radio is used to wirelessly communicate with mobile device 23 via BLE.

Control device 22 further has software 34 (which may include one or more software applications) stored internally in, for example, memory 30, or stored in external memory (e.g., database, storage array, network storage devices, etc.) accessible by the control device 22 via an external connection. Software 34 may include any software or program that configures processing circuitry 26 to perform the steps or processes of the present disclosure.

The processing circuitry 26 may be configured to control any of the methods and/or processes described herein and/or to cause such methods, and/or processes to be performed, e.g., by control device 22. One or more processors 28 may cause control device 22 to perform the functionality described herein. The memory 30 is configured to store data, including but not limited to files and/or other data. In some embodiments, the software 34 may include instructions that, when executed by the processor 28 and/or processing circuitry 26, causes the processor 28 and/or processing circuitry 26 to perform the processes described herein with respect to control device 22. Accordingly, by having computer instructions stored in memory 30 accessible to the processor 28, the processor 28 may be configured to perform the actions described herein.

FIG. 4 is a block diagram illustrating several example premises devices 20a-n (referred to collectively herein as premises devices 20) according to some embodiments of the present disclosure. As shown, premises device 20a comprises hardware 36. The hardware 36 may include processing circuitry 38. The processing circuitry 38 may include one or more processors 40 (e.g., one or more premises device processors) and one or more memories 42. Each processor 40 may include and/or be associated with one or more central processing units, data buses, buffers, and interfaces to facilitate operation. In addition to or instead of a processor 40 and memory 42, the processing circuitry 38 may comprise other types of integrated circuitry that performs various functionality. Integrated circuitry may include one or more processors 40, processor cores, FPGAs, ASICs, GPUs, SoCs, or other components configured to execute instructions. The processor 40 may be configured to access (e.g., write to and/or read from) the memory 42, which may comprise any kind of volatile and/or nonvolatile memory, e.g., cache, buffer memory, RAM, ROM, optical memory, and/or EPROM. Further, memory 42 may be embodied in the form of one or more storage devices. The processing circuitry may be configured to perform various functionality described herein. For example, computer instructions may be stored in memory 42 and/or another computer-readable medium that, when executed by processor 40, causes the processor 40 to perform various functionality associated premises device 20a.

Hardware 36 may include communication interface 44 facilitating communication between premises device 20a and one or more elements in system 10. For example, communication interface 44 may be configured for establishing and maintaining at least a wireless or wired connection with one or more elements of system 10 such as control device 22 and/or computing environment 14.

Premises device 20a further has software 46 (which may include one or more software applications) stored internally in, for example, memory 42, or stored in external memory (e.g., database, storage array, network storage devices, etc.) accessible by the premises device 20a via an external connection. Software 46 may include any software or program that configures processing circuitry 38 to perform the steps or processes of the present disclosure.

The processing circuitry 38 may be configured to control any of the methods and/or processes described herein and/or to cause such methods, and/or processes to be performed, e.g., by premises device 20a. Processor 40 corresponds to one or more processors 40 for performing premises device 20a functions described herein. The memory 42 is configured to store data and/or files and/or other information/data. In some embodiments, the software 46 may include instructions that, when executed by the processor 40 and/or processing circuitry 38, causes the processor 40 and/or processing circuitry 38 to perform the processes described herein with respect to premises device 20a. Accordingly, by having computer instructions stored in memory 42 accessible to the processor 40, the processor 40 may be configured to perform the actions described herein.

With reference to the doorbell premises device 20b in FIG. 4, in one or more embodiments, doorbell premises device 20b includes the same or similar hardware as premises device 20a described above, except that doorbell premises device 20b further includes one or more of camera 48, microphone 50 or speaker 52. Camera 48 is configured to capture media such as, for example, at least one of video or still images. Microphone 50 is configured to capture media such as, for example, audio proximate microphone 50. In one example, microphone 50 may capture an audible password spoken by a person proximate to microphone 50. Speaker 52 may be configured to emit one or more audible sounds.

In one or more embodiments, doorbell premises device 20b may be a networked doorbell having a camera 48 and a microphone 50.

With reference to the door lock premises device 20c in FIG. 4, in one or more embodiments, door lock premises device 20c includes the same or similar hardware as premises device 20a described above, except that door lock premises device 20c further includes locking element 54. For example, locking element 54 may comprise an electrically actuatable door locking mechanism where door lock premises device 20c may receive a command to lock or unlock the door locking mechanism and actuate the door locking mechanism according to the command. In one or more embodiments, door lock premises device 20c is positioned at and/or proximate an access point or location of premises 13.

In one or more embodiments, premises device 20d includes the same or similar hardware as premises device 20a described above, except that door lock premises device 20c further includes one or more sensor elements 56 configured to perform sensing as described herein. In one or more embodiments, user interface premises device 20n is a monitoring interface device that includes the same or similar hardware as premises device 20a described above, except that user interface premises device 20n further includes user interface 58 such as a control panel touchscreen or buttons to allow a user to interface with user interface premises device 20n. In other words, each premises device 20 may comprise hardware and software that is similar to the hardware and software described with respect to premises device 20a, but with other elements to provide desired functionality, e.g., sensing, locking, user interface, etc.

Referring to FIG. 5, shown is a block diagram illustrating an example mobile device 23. As shown, mobile device 23 comprises hardware 60. The hardware 60 may include processing circuitry 62. The processing circuitry 62 may include one or more processors 64 and one or more memories 66. Each processor 64 may include and/or be associated with one or more central processing units, data buses, buffers, and interfaces to facilitate operation. In addition to or instead of a processor 64 and memory 66, the processing circuitry 62 may comprise other types of integrated circuitry that perform various functionality. Integrated circuitry may include one or more processors 64, processor cores, FPGAs, ASICs, GPUs, SoCs, or other components configured to execute instructions. The processor 64 may be configured to access (e.g., write to and/or read from) the memory 66, which may comprise any kind of volatile and/or nonvolatile memory, e.g., cache, buffer memory, RAM, ROM, optical memory, and/or EPROM. Further, memory 66 may be embodied in the form of one or more storage devices. The processing circuitry 62 may be configured to perform various functionality described herein. For example, computer instructions may be stored in memory 66 and/or another computer-readable medium that, when executed by processor 64, causes the processor 64 to perform various functionality described herein. Memory 66 may include authentication data 68 that may be transmitted from mobile device 23 for use in authenticating mobile device 23 with user interface premises device 20n such as for establishing a wireless connection with user interface premises device 20n.

Hardware 60 may include communication interface 70 facilitating communication between mobile device 23 and one or more elements in system 10. For example, communication interface 70 may be configured for establishing and maintaining at least a wireless or wired connection with one or more elements of system 10 such as with, for example, user interface premises device 20n.

Mobile device 23 further has software 72 stored internally in, for example, memory 66, or stored in external memory (e.g., database, storage array, network storage devices, etc.) accessible by the mobile device 23 via an external connection. Software 72 may include any software or program that configures processing circuitry 62 to perform the steps or processes of the present disclosure. Software 72 may include or more software applications (e.g., mobile application) for interfacing with mobile device 23.

The processing circuitry 62 may be configured to control any of the methods and/or processes described herein and/or to cause such methods, and/or processes to be performed, e.g., by mobile device 23. One or more processors 64 may cause mobile device 23 to perform functionality described herein. The memory 66 is configured to store data, including but not limited to files and/or other data. In some embodiments, the software 72 may include instructions that, when executed by the processor 64 and/or processing circuitry 62, causes the processor 64 and/or processing circuitry 62 to perform the processes described herein with respect to mobile device 23. Accordingly, by having computer instructions stored in memory 66 accessible to the processor 64, the processor 64 may be configured to perform the actions described herein.

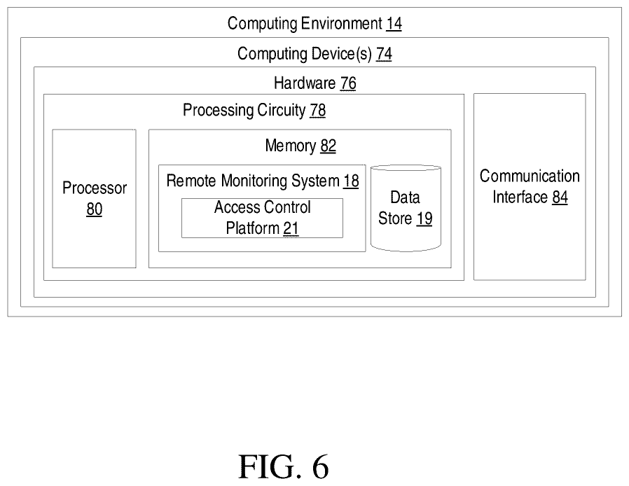

FIG. 6 is a block diagram illustrating the example computing environment 14 according to various embodiments. As shown, the computing environment 14 may include one or more computing devices 74. In embodiments using multiple computing devices 74, the computing devices 74 may be located in a single installation or may be distributed among many different geographic locations. As shown, each computing device 74 comprises hardware 76. The hardware 76 may include processing circuitry 78. The processing circuitry 78 may include one or more processors 80 and one or more memories 82. Each processor 80 may include and/or be associated with one or more central processing units, data buses, buffers, and interfaces to facilitate operation. In addition to or instead of a processor 80 and memory 82, the processing circuitry 78 may comprise other types of integrated circuitry that perform various functionality. Integrated circuitry may include one or more processors 80, processor cores, FPGAs, ASICS, GPUs, SoCs, or other components configured to execute instructions. The processor 80 may be configured to access (e.g., write to and/or read from) the memory 82, which may comprise any kind of volatile and/or nonvolatile memory, e.g., cache, buffer memory, RAM, ROM, optical memory, and/or EPROM. Further, memory 82 may be embodied in the form of one or more storage devices. The processing circuitry 78 may be configured to perform various functionality described herein. For example, computer instructions may be stored in memory 82 and/or another computer-readable medium that, when executed by processor 80, causes the processor 80 to perform various functionality.

Hardware 76 may include communication interface 84 facilitating communication between one or more elements in system 10. For example, communication interface 84 may be configured for establishing and maintaining at least a wireless or wired connection with one or more elements of system 10 such as control devices 22, premises devices 20, etc.

The processing circuitry 78 may be configured to control any of the methods and/or processes described herein and/or to cause such methods, and/or processes to be performed, e.g., in computing environment 14. Processor 80 corresponds to one or more processors 80 for performing computing device 74 functions described herein.

The memory 82 is configured to store data, such as files, remote monitoring system data, and/or other information/data. Also stored in the memory 82 and executable by the processor 80 is the remote monitoring system 18. Although FIG. 6 shows the remote monitoring system 18 being in a single computing device 74, the remote monitoring system 18 may execute in multiple computing devices 74 of the computing environment 14. To perform the functionality of the remote monitoring system 18, the memory 82 may include instructions that, when executed by the processor 80 and/or processing circuitry 78, causes the computing device 74 to perform the functionality performed by the remote monitoring system 18 described herein.

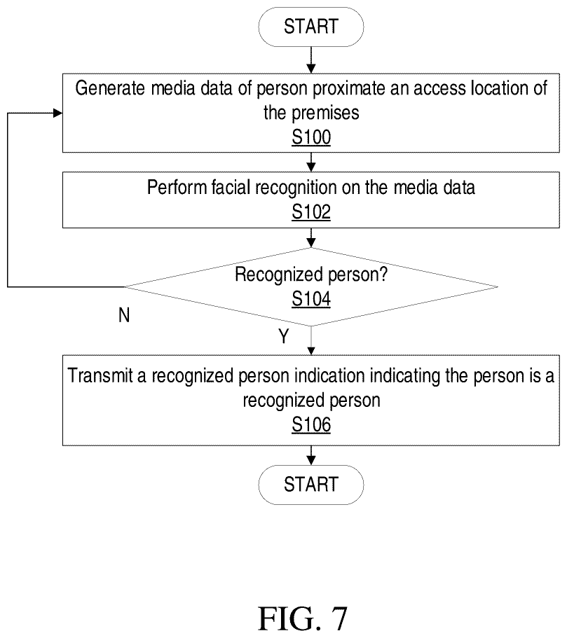

FIG. 7 is a flowchart of an example process implemented by doorbell premises device 20b according to some embodiments of the present disclosure. In this example, the doorbell premises device 20b is embodied in the form of a networked doorbell (e.g., a smart doorbell) that includes a camera 48, microphone 50, and speaker 52. Furthermore, in the following discussion, the doorbell premises device 20b has been installed and positioned so that the field of view of the camera of the doorbell premises device 20b captures an area proximate to an entrance of the premises 13. As an example, the doorbell premises device 20b may be installed so that the field of view of its camera captures at least a portion of a walkway, porch, etc. in front of the front door of a home.

Beginning at block S100, the process comprises the doorbell premises device 20b generating media data of a person proximate an access location of the premises 13 (Block S100). For example, doorbell premises device 20b may capture images and/or video of a person that is approaching and/or proximate doorbell premises device 20b and/or an access point of the premises 13. The doorbell premises device 20b then performs facial recognition on the media data (Block S102). For example, the doorbell premises device 20b may be configured to perform facial recognition on the video and/or images captured by doorbell premises device 20b.

At block S104, the doorbell premises device 20b determines whether the person is a recognized person based on facial recognition (Block S104). For example, recognizing the person may comprise using facial recognition to attempt to determine whether the face of the person matches a predefined profile that may include one or more stored facial recognition characteristics. If the person is not recognized by doorbell premises device 20b, the process may return to block S100.

At block S104, in response to recognizing the person that is proximate the access location, the doorbell premises device 20b may transmit to the computing environment 14 a recognized person message (e.g., authentication data) indicating the person is a recognized person (Block S106). For example, doorbell premises device 20b may transmit the recognized person message to computing environment 14b via network 15 or to computing environment 14a via control device 22.

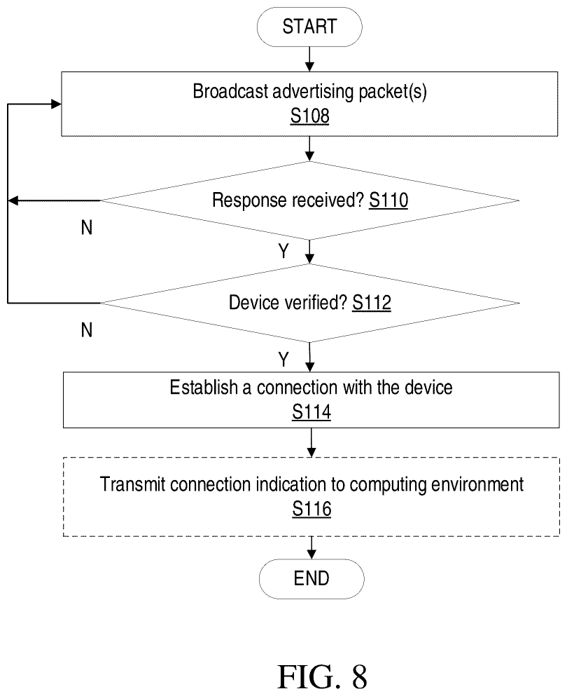

FIG. 8 is a flowchart of an example process implemented by user interface premises device 20n according to some embodiments of the present disclosure. User interface premises device 20n is configured to broadcast advertising packet(s) (Block S108). For example, user interface premises device 20n is a user interface device (e.g., wall-mountable panel device, wall-mounted alarm system panel, etc.) configured to broadcast BLE advertising packets to allow one or more devices to attempt to connect with the user interface premises device 20n. User interface premises device 20n is configured to determine whether a response has been received (Block S110). For example, user interface premises device 20n may determine whether a response to the BLE advertisements has been received from a device.

If user interface premises device 20n determines that no response has been received, the process may return to Block S108. If user interface premises device 20n determines a response has been received, user interface premises device 20n is configured to verify the authentication data included in the response (Block S112). In one or more embodiments, the response from a device (e.g., mobile device 23), may include authentication data. Authentication data may include a security token or other data that is usable to authenticate a device with user interface premises device 20n. In one or more embodiments, the authentication data may be stored in mobile device 23 in response to registering mobile device 23 with computing environment 14.

If user interface premises device 20n determines that authentication data is not verified, the process may return to Block S108. For example, user interface premises device 20n may determine that mobile device 23 is an unknown device to user interface premises device 20n based on a comparison of the authentication data in the response and previously stored registration data. If user interface premises device 20n determines that authentication data is verified, user interface premises device 20n establishes a connection with mobile device 23 (Block S114). For example, if user interface premises device 20n is able to authenticate mobile device 23 with premises monitoring system 12 using authentication data (e.g., determine mobile device 23 is a known device to user interface premises device 20n), user interface premises device 20n may establish a BLE connection with mobile device 23.

In one or more embodiments, user interface premises device 20n may be configured to indicate to the computing environment 14 that a connection has been established with mobile device 23, i.e., transmit a message indicating that a connection has been established to computing environment 14 (Block S116). In one or more embodiments, the connection indication may correspond to an authentication indication that is usable by computing environment 14 as part of the process for authenticating a recognized person. Alternatively, Block S116 may be omitted from the process of FIG. 8 or skipped such as if, for example, mobile device 23 transmits the connection indication to computing environment 14.

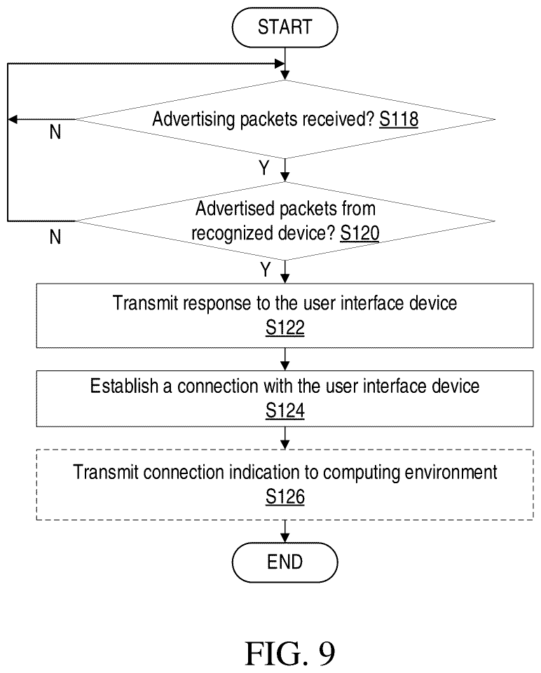

FIG. 9 is a flowchart of an example process implemented by mobile device 23 according to some embodiments of the present disclosure. Mobile device 23 is configured to determine whether advertising packets have been received (Block S118). For example, as described above with respect to FIG. 8, the advertising packets may be BLE advertising packets. If the advertising packets have not been received, mobile device 23 may return to Block S118. If the advertising packets have been received by mobile device 23, mobile device 23 is configured to determine whether the advertising packets are from a device that is recognized by mobile device 23 (Block S120). For example, mobile device 23 may have been previously registered with premises monitoring system 12 such that mobile device 23 can recognize that the advertising packets are from user interface premises device 20n.

If mobile device 23 does not recognize the device associated with the advertising packets, the process may return to Block S118. If mobile device 23 recognizes user interface premises device 20n from the advertising packets, mobile device 23 is configured to transmit a response to user interface premises device 20n (Block S122). In one or more embodiments, the response includes authentication data that is usable by user interface premises device 20n to authenticate mobile device 23 as described with respect to FIG. 8.

Still referring to FIG. 9, after transmitting the response to user interface premises device 20n, mobile device 23 is configured to establish a connection with user interface premises device 20n (Block S124). In one or more embodiments, mobile device 23 is configured to transmit a message (e.g., a connection indication) to computing environment 14 indicating that a connection has been established with user interface premises device 20n (Block S126). The indication may correspond an authentication indication that is usable by computing environment 14 as part of the determination as to whether to authenticate a recognized person with computing environment 14 and/or premises monitoring system 12.

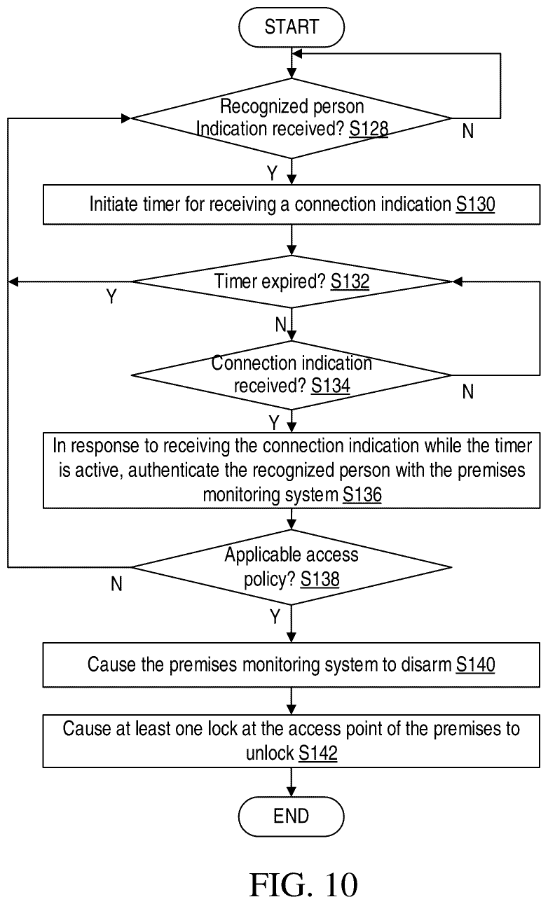

FIG. 10 is a flowchart of an example process implemented by access control platform 21 of computing environment 14 according to some embodiments of the present disclosure. For example, access control platform 21 is configured to determine whether a recognized person indication has been received (Block S128). For example, a recognized person indication may be received from user interface premises device 20n and/or mobile device 23 as described herein. If a recognized person indication is not received, access control platform 21 may return to block S128. If a recognized person indication is received, access control platform 21 initiates a timer for receiving a connection indication (Block S130). For example, a connection indication may be a message indicating that mobile device 23 has established a wireless connection with user interface premises device 20n, which access control platform 21 interprets as an indication that the recognized person associated with mobile device 23 may be authenticated, as described herein. In one or more embodiments, the timer is a countdown timer.

Access control platform 21 is configured to determine whether the timer has expired (Block S132). If access control platform 21 determines that the timer has expired, the process may return to Block S128. According to one or more embodiments, Block S132 may be skipped immediately after the timer is initiated in Block S130. If access control platform 21 determines the timer has not expired or is still active, access control platform 21 is configured to determine whether a connection indication has been received (Block S134). If access control platform 21 determines a connection indication has not been received, access control platform 21 may return to block S132. If access control platform 21 determines a connection indication has been received while the timer is active or not expired, access control platform 21 is configured to authenticate the recognized person associated with mobile device 23 with premises monitoring system 12 and/or computing environment 14 (Block S136).

Access control platform 21 is configured to determine whether there is an applicable access policy for the recognized person (Block S138). For example, access control platform 21 may be configured to determine whether the recognized person is associated with an access policy for premises 13, where the access policy indicates a type of access (e.g., event-based access, time-based access, etc.) allowed for the recognized person that has been authenticated. If there is no applicable access policy for the recognized person, the recognized person may be denied access to premises 13 and the process may return to block S128. If access control platform 21 determines the recognized person is associated with an access policy, access control platform 21 is configured to cause the premise monitoring system 12 to disarm (Block S140) and to cause at least one lock at the access point of premises 13 to unlock (Block S142). Alternatively or in addition to the actions of Blocks S140 and/or S142, access control platform 21 may cause premises monitoring system 12 to perform one or more other actions based on the access policy.

While FIG. 10 describes the recognized person indication being received before the connection indication and the recognized person indication triggers and/or initiates the timer, in one or more embodiments, the connection indication may be received before the recognized person indication. In this case, the connection indication may trigger or initiate the timer for receiving a message indicating that the person has been recognized. That is, the two separate authentication indications (e.g., connection indication and recognized person indication) may be received in any order, where the authentication indication received first in time initiates the timer for receiving the next authentication indication.

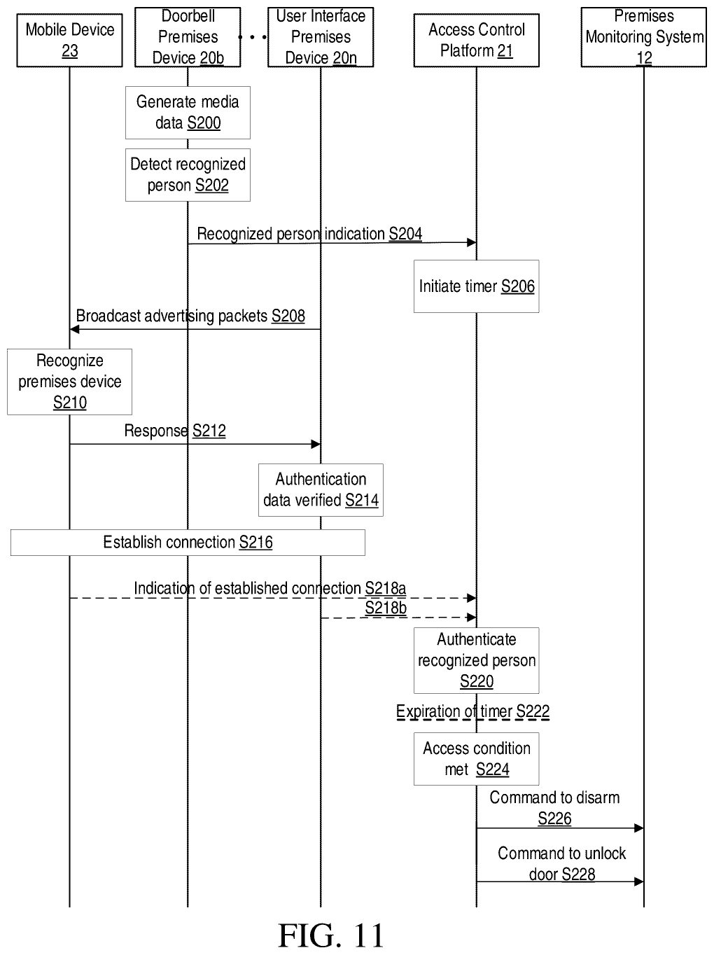

FIG. 11 is a sequence diagram of an example process according to various embodiments of the present disclosure. It may be assumed that the recognized person described below has already paired his or her mobile device 23 with premises monitoring system 12 at some previous time, and that an image or video of the recognized person's face is stored in a “face library” accessible by doorbell premises device 20b such that doorbell premises device 20b can detect a recognized person in media data captured or generated by doorbell premises device 20b.

Doorbell premises device 20b is configured to generate media data, as described herein (Step S200). For example, a person approaches a front door of premises 13 and is captured in the field of view of doorbell premises device 20b. Doorbell premises device 20b is configured to detect a recognized person in the media data generated by doorbell premises device 20b, as described herein (Block S202). Doorbell premises device 20b is configured to transmit a recognized person indication to access control platform 21 of computing environment 14, as described herein (Step S204). For example, the recognized person indication may be transmitted to computing environment 14b, where computing environment 14b transmits the recognized person indication to access control platform 21. In another example, the recognized person indication is transmitted to access control platform 21 from doorbell premises device 20b. In one or more embodiments, the recognized person indication is one factor of authentication that is used by access control platform 21 for determining whether to authenticate a person with premises monitoring system 12.

Access control platform 21 is configured to initiate a timer in response to receiving the recognized person indication, as described herein (Step S206). User interface premises device 20n is configured to broadcast advertisement packets, as described herein (Step S208). For example, user interface premises device 20n that is configured to broadcast BLE advertisement packets. Step S208 may occur periodically while user interface premises device 20n is active and/or where the broadcasting of advertising packets is not dependent on one or more other steps in FIG. 10.

Mobile device 23 is configured to receive the broadcast advertising packets and determine that user interface premises device 20n is a recognized device based on data in the advertising packets, as described herein (Step S210). That is, for example, when mobile device 23 comes in range of a BLE radio of user interface premises device 20n, mobile device 23 receives BLE advertising packets broadcast by the BLE radio of user interface premises device 20n. For example, mobile device 23 may use the information in the advertisement packet(s) and previous registration stored in mobile device 23 to determine that the user interface premises device 20n is a known device to mobile device 23. Mobile device 23 is configured to transmit a response to the advertisement packet(s) where the response includes authentication data, as described herein (Step S212).

User interface premises device 20n verifies the authentication data, and, if the authentication data is verified, user interface premises device 20n is configured to establish a wireless connection with mobile device 23, as described herein (Steps S214-S216). In one or more embodiments, mobile device 23 is configured to transmit an indication of the established connection (i.e., connection indication) to access control platform 21, as described herein (Step S218a). Alternatively or in addition to Step S218a, user interface premises device 20n is configured to transmit the indication of the established connection to access control platform 21, as described herein. The connection indication may correspond to another factor of authentication that is used by access control platform 21 of computing environment 14.

Access control platform 21 is configured to authenticate the recognized person based on the recognized person indication and the receiving of the connection indication before the timer expires, as described herein (Step S220). In this example, the authentication criteria for authenticating a recognized person may require receiving two authentication indications within a predefined time period defined by the timer. After Step S220, the timer may be allowed to expire or may be reset by access control platform 21 (Step S222). Access control platform 21 is configured to determine whether an access condition associated with the recognized person is met, as described herein. If access control platform 21 determines the access condition is met (Step S224), access control platform 21 is configured to transmit a command for premises monitoring system 12 to disarm (Step S226). Access control platform 21 is further configured to transmit a command for premises monitoring system 12 to unlock a door at an access location of the premises 13 (Step S228).

The concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspect. Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions and/or acts specified in the flowchart and/or block diagram block or blocks.

The functions and acts noted in the blocks may occur out of the order noted in the operational illustrations. For example, two blocks shown in succession may in fact be executed substantially concurrently or the blocks may sometimes be executed in the reverse order, depending upon the functionality and/or acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In addition, unless mention was made above to the contrary, the accompanying drawings are not to scale. A variety of modifications and variations are possible in light of the above teachings without departing from the scope and spirit of the present disclosure.

1. A system, comprising:
at least one computing device comprising:
at least one processor; and
at least one memory storing computing instructions that, when executed by the at least one processor, cause the at least one computing device to:
receive a recognized person message, the recognized person message indicating a recognized person has been detected in video captured by a video doorbell device installed proximate a door of a premises, the recognized person message corresponding to a first authentication factor for authenticating the recognized person;
receive a connection message, the connection message indicating a wireless connection has been established between a keypad device for a premises monitoring system at the premises and a mobile device corresponding to the recognized person, the wireless connection complying with a short-range wireless communication protocol, the connection message corresponding to a second authentication factor for authenticating the recognized person; and
in response to at least receiving the recognized person message and the connection message, grant the recognized person access to the premises by at least:
causing the premises monitoring system to disarm; and
causing an electronic door lock securing the door to unlock.

2. The system of claim 1, wherein the short-range wireless communication protocol with which the connection complies is a BLUETOOTH LOW ENERGY (BLE) protocol.

3. The system of claim 1, wherein computing instructions are further configured to cause the at least one computing device to receive the connection message from the keypad device for the premises monitoring system via a network.

4. A system, comprising:
at least one computing device comprising:
at least one processor; and
at least one memory storing computing instructions that, when executed by the at least one processor, cause the at least one computing device to:
receive a recognized person message indicating a recognized person has been detected proximate an access location of the premises;
receive a connection message, the connection message indicating a wireless connection has been established between a premises monitoring system and a mobile device corresponding to the recognized person; and
in response to at least receiving the recognized person message and the connection message:
cause the premises monitoring system to disarm; and
cause an electronic door lock securing the access location of the premises to unlock.

5. The system of claim 4, wherein the computing instructions are further configured to cause the at least one computing device to:
in response to receiving the recognized person message, initiate a timer for receiving the connection message; and
cause the premises monitoring system to disarm and cause the electronic door lock to unlock further in response to receiving the connection message before the timer expires.

6. The system of claim 4, wherein the computing instructions are further configured to cause the at least one computing device to receive the connection message from the mobile device via a network.

7. The system of claim 4, wherein the computing instructions are further configured to cause the at least one computing device to receive the connection message from a device of the premises monitoring system via a network.

8. The system of claim 4, wherein the computing instructions are further configured to cause the at least one computing device to receive the connection message from a user interface premises device of the premises monitoring system via a network.

9. The system of claim 4, wherein the computing instructions are further configured to cause the at least one computing device to receive the connection message from a keypad device of the premises monitoring system via a network.

10. The system of claim 4, wherein the recognized person message corresponds to media data captured by a doorbell premises device of the premises monitoring system.

11. The system of claim 9, wherein the recognized person message corresponds to media data captured by a camera of the premises monitoring system.

12. The system of claim 10, wherein the recognized person message is received via a network from a computing environment that provides remote data storage for a premises device of the premises monitoring system.

13. The system of claim 4, wherein the wireless connection is established using a short-range wireless communication protocol.

14. A method implemented by a system, the system comprising at least one computing device, the method comprising:
receiving a recognized person message indicating a recognized person has been detected proximate an access location of the premises;
receiving a connection message, the connection message indicating a wireless connection has been established between a premises monitoring system and a mobile device corresponding to the recognized person; and
in response to at least receiving the recognized person message and the connection message:
causing the premises monitoring system to disarm; and
causing an electronic door lock securing the access location of the premises to unlock.

15. The method of claim 14, further comprising
in response to receiving the recognized person message, initiating a timer for receiving the connection message; and
causing the premises monitoring system to disarm and cause the electronic door lock to unlock further in response to receiving the connection message before the timer expires.

16. The method of claim 14, further comprising one of:
causing the at least one computing device to receive the connection message from the mobile device via a network;
causing the at least one computing device to receive the connection message from a device of the premises monitoring system via a network;
causing the at least one computing device to receive the connection message from a user interface premises device of the premises monitoring system via a network; or
causing the at least one computing device to receive the connection message from a keypad device of the premises monitoring system via a network.

17. The method of claim 14, wherein the recognized person message corresponds to media data captured by a doorbell premises device of the premises monitoring system.

18. The method of claim 14, wherein the recognized person message corresponds to media data captured by a camera of the premises monitoring system.

19. The method of claim 14, wherein the recognized person message is received via network from a computing environment that provides remote data storage for a premises device of the premises monitoring system.

20. The method of claim 14, wherein the wireless connection is established using a short-range wireless communication protocol.
